(19) United States
(12) Patent Application Publication
(10) Pub. No.: US 2007/0014604 A1
(43) Pub. Date: Jan. 18, 2007

(54) Printer

(75) Inventor: Haruhiko Arai, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/487,389

(22) Filed: Jul. 17, 2006

(30) Foreign Application Priority Data
Jul. 15, 2005 (JP) 2005-206595

(51) Int. Cl. G03G 15/20

(52) U.S. Cl. 399/341

(57) ABSTRACT

A printer includes a surface treatment section which subjects an image recording medium to a surface treatment by conveying the image recording medium on a belt-shaped surface treatment means while the image recording medium is abutted against the belt-shaped surface treatment means, a position adjusting section which is disposed upstream of the surface treatment section, and moves the image recording medium in a width direction orthogonal to a conveying direction in the surface treatment section as necessary and a cutting section which is disposed downstream of the surface treatment section, adjusts a cutting position in the width direction in accordance with information about movement of the image recording medium in the position adjusting section, and cuts the image recording medium in accordance with a print size of a print to be outputted.

### BACKGROUND OF THE INVENTION

The present invention relates to a printer for performing surface treatment such as glossing treatment by pressing a surface treatment belt against an image recording medium on which an image has been recorded. More particularly, the present invention relates to a printer capable of preventing image quality degradation due to a stain on a surface treatment belt as well as degradation of the belt.

It is known that in electrophotographic image formation or the like, prints having glossiness that is equivalent to that of photographic prints are produced using an image recording medium obtained by forming a transparent resin layer made of a thermoplastic resin on a surface of a substrate.

In the print production, after recording of images on the image recording medium or transparent resin layer, the transparent resin layer is abutted against surface treatment means having high smoothness to carry out surface treatment through heating under pressure thereby melting the transparent resin layer. The transparent resin layer is then solidified to smooth a surface of the image recording medium, thereby imparting glossiness to the image recording medium.

For instance, JP 2004-109860 A discloses an image forming apparatus in which prints similar to photographic prints are obtained by forming toner images on an image receiving medium (recording medium) having a transparent resin layer and thereafter fixing the toner images with a fixing apparatus including a fixing belt that is an endless belt whose surface smoothness is high, rollers having a heating roller which stretch the fixing belt therearound, and a nip roller which is pressed against the fixing belt or heating roller, that is, nips the endless belt together with the heating roller.

To be more specific, in JP 2004-109860 A, after an electrophotographic toner image has been formed on the image receiving medium or recording sheet having the transparent resin layer, the image receiving medium is nipped and conveyed between the fixing belt and the nip roller in the state in which the transparent resin layer or image recording surface is directed toward the fixing belt. Through the nipping and conveyance, the transparent resin layer is abutted/pressed against the fixing belt and is heated to fix the toner image. The transparent resin layer is also melted so as to slightly stick to the fixing belt. Following this, the transparent resin layer is cooled/solidified during conveyance on the fixing belt. Then, after the conveyance by a predetermined length, the image receiving medium is peeled off the fixing belt. The toner image is thus fixed. In addition, the surface properties of the fixing belt are transferred onto the transparent resin layer of the image receiving medium and glossiness is imparted to a surface of a print.

Even when foreign matter such as dirt or dust has adhered to an area of the fixing belt against which the image receiving medium is abutted, the foreign matter is transferred onto the image receiving medium at the time of the fixation/surface treatment. As a result, each time the fixation/surface treatment is performed, the fixing belt is cleaned by the image receiving medium to be kept clean. In addition, the amount of the foreign matter transferred onto the image receiving medium through one fixation/surface treatment operation is extremely small and there is no adverse effect on the print quality.

However, as the fixation/surface treatment is repeatedly performed, foreign matter such as dirt adheres to and accumulates on an area of the fixing belt which does not contact the image receiving medium. Therefore, when the size of the image receiving medium is changed and an image receiving medium having a large width (i.e., having a large length in a direction orthogonal to a conveying direction) is used, for instance, unevenness in print glossiness or the like occurs due to the foreign matter, that is, print quality is degraded.

In ordinary cases, print production using such an image receiving medium having a transparent resin layer is performed using about two kinds of image receiving media having different widths appropriate for the photographic prints obtained. When the surface treatment of an image receiving medium of a specified size is repeatedly performed, the image receiving medium is only abutted against a specified area of the fixing belt, so only this area of the belt is degraded at a high pace. In particular, a portion of the fixing belt against which edge portions (i.e., end portions in a width direction) of the image receiving medium are abutted, tends to be damaged, that is, only a specified portion of the fixing belt is degraded, which leads to shortening of the service life of the fixing belt, degradation of the surface treatment performance, and the like.

Meanwhile, JP 2003-131524 A discloses that such inconveniences are obviated by changing as appropriate the position in the width direction of a recording medium in the case where there is a margin in the width direction of the recording medium when image formation including fixation with a belt is performed.

With the method disclosed in JP 2003-131524 A, foreign matter having adhered to a surface of the fixing belt is transferred to the image receiving medium in such a trace amount that glossiness or other property is not adversely affected. Therefore, accumulating foreign matter can be prevented from adversely affecting the image quality.

Degradation and damage of the fixing belt due to contact of the end portions of the image receiving medium with a part of the fixing belt can be also significantly suppressed.

Mainly produced photographic prints are so-called frameless prints in which images are recorded or reproduced up to end portions of the prints. Therefore, even when prints whose glossiness is equivalent to that of photographic prints are produced by electrophotography on an image recording medium such as the above-mentioned image receiving medium having a transparent resin layer, it is required to produce the frameless prints.

When prints are formed by electrophotography, images are not formed up to the end portions of the image receiving medium in order to prevent the inside of the apparatus from being contaminated by toner. Therefore, when frameless prints are produced by electrophotography, images larger than prints are formed on the image receiving medium with its periphery made blank and then the image receiving medium is cut in accordance with the print size, thereby producing the frameless prints.

However, when the image receiving medium is moved in the width direction to perform fixing treatment or surface treatment as described above during print production that requires such a cutting step, the position in the width direction of the image receiving medium to be conveyed for the cutting step varies in accordance with the position in the width direction of the image receiving medium at the time of fixation.

Therefore, a step for returning the position in the width direction of the image receiving medium to the original position is necessary to carry out prior to the cutting step, which however requires plural means for moving the image receiving medium in the width direction, making it impossible to avoid an increase in apparatus size, an increase in apparatus complexity, and an increase in apparatus cost.

### SUMMARY OF THE INVENTION

An object of the present invention is to solve the above-mentioned conventional problems, and to provide a printer which includes: a surface treatment section for treating an image recording medium having a transparent resin layer made of a thermoplastic resin by conveying the image recording medium on a surface treatment belt with the former contacting the latter; and an image recording medium cutting section for obtaining a frameless print, and which prevents print quality degradation due to foreign matter having adhered to the surface treatment belt, lengthens the service life of the belt, and suppresses increases in complexity, size, and cost of the apparatus.

In order to attain the object described above, the present invention provides a printer comprising: a surface treatment section which subjects an image recording medium to a surface treatment by conveying the image recording medium on a belt-shaped surface treatment means while the image recording medium is abutted against the belt-shaped surface treatment means; a position adjusting section which is disposed upstream of the surface treatment section, and moves the image recording medium in a width direction orthogonal to a conveying direction in the surface treatment section as necessary; and a cutting section which is disposed downstream of the surface treatment section, adjusts a cutting position in the width direction in accordance with information about movement of the image recording medium in the position adjusting section, and cuts the image recording medium in accordance with a print size of a print to be outputted.

It is preferable in the present invention that the printer further comprise a line unifying section which is provided downstream of the cutting section and which, when the cutting section cut out prints in two or more lines in the width direction, moves the prints in the two or more lines to unify into one line in the conveying direction, wherein the line unifying section adjusts an amount of movement of the prints in the width direction in accordance with information about movement of the image recording medium in the position adjusting section.

It is further preferable that the position adjusting section change movement of the image recording medium in the width direction for each order, for each predetermined number of sheets of the image recording medium or for each elapsed time.

It is still further preferable that the position adjusting section move the image recording medium in the width direction only on one side in the width direction with respect to a reference position at which the image recording medium is not moved in the width direction, and an amount of movement be equal to or less than a width of end portions in the width direction cut in the cutting section.

It is still further preferable that the the position adjusting section move the image recording medium on both sides in the width direction with respect to a reference position at which the image recording medium is not moved in the width direction, and an amount of movement is equal to or less than half of a width of end portions in the width direction cut in the cutting subsection.

According to the present invention having the configuration described above, the position in the width direction of an image recording medium to be subjected to surface treatment is adjusted as appropriate, for example, on an order basis, with a printer in which an image recording medium having a layer made of a thermoplastic resin formed on the surface thereof is used and the image recording medium is conveyed while being abutted against the surface treatment belt to carry out surface treatment for imparting glossiness, and the surface-treated image recording medium is cut to produce a frameless print. As a result, it is possible to prevent degraded print quality such as deteriorated glossiness or uneven glossiness from occurring due to foreign matter such as dirt or dust having adhered to the surface treatment belt. Damage or degradation of the surface treatment belt can be also prevented from occurring due to contact of the image recording medium only with a specified area of the surface treatment belt, in particular, contact of the end portions or edge portions of the image recording medium only with specified spots of the surface treatment belt to thereby lengthen its service life.

The cutting position of the image recording medium is adjusted in the cutting section using information about the movement in the width direction of the image recording medium to be subjected to the surface treatment. Thus, there is no need to separately provide a step of moving the image recording medium in the width direction, which prevents the apparatus from being upsized or made more complex, or the cost from being increased.

By appropriately setting the amount of movement in the width direction of the image recording medium, it is also possible to prevent degradation of image quality or print quality due to foreign matter having adhered to the belt with more reliability regardless of the size (i.e. size in the width direction) of the image recording medium, and to prevent an increase in size of the cutting section.

### BRIEF DESCRIPTION OF THE DRAWINGS

FIG. 1 is a conceptual diagram of an embodiment of a printer according to the present invention;

FIGS. 2A and 2B are each a conceptual diagram for illustrating the movement in the width direction of a recording sheet in the printer shown in FIG. 1;

FIG. 3 is a plan view conceptually showing a cutting subsection in the printer shown in FIG. 1; and

FIGS. 4A and 4B are each a conceptual diagram showing an example of image recording in the printer shown in FIG. 1.

### DETAILED DESCRIPTION OF THE PREFERRED EMBODIMENTS

The printer according to the present invention will be described below in detail based on preferred embodiments with reference to the accompanying drawings.

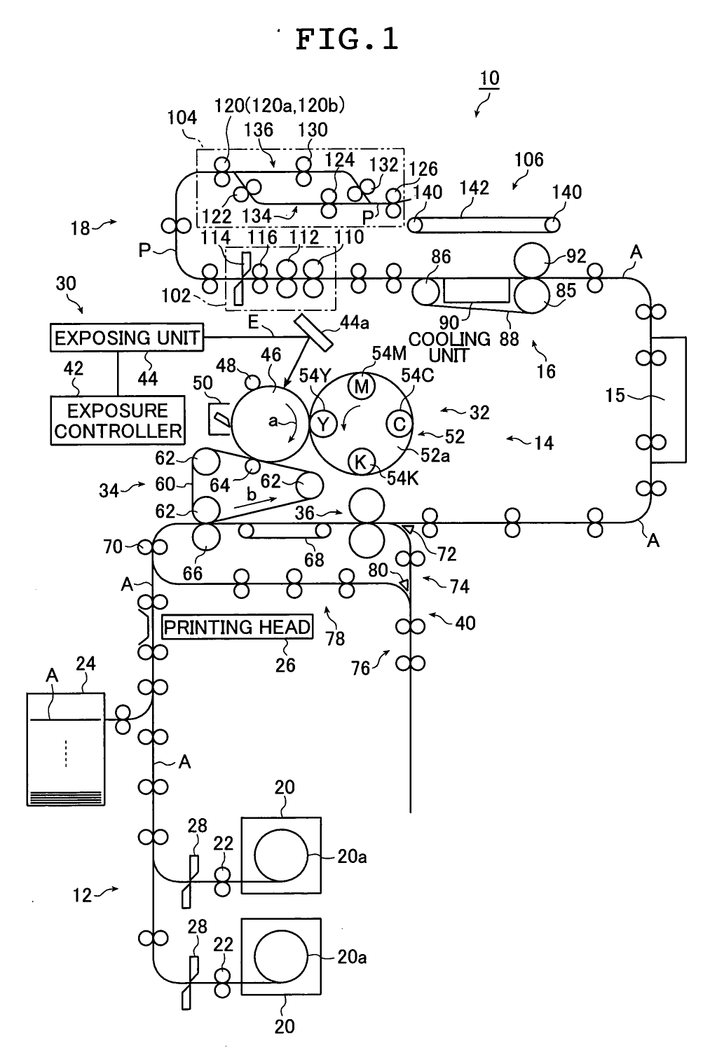

FIG. 1 is a conceptual diagram showing an embodiment of a printer according to the present invention.

A printer 10 shown in FIG. 1 produces a print P by recording an image on a recording sheet A or image receiving medium by an electrophotographic system and basically includes a recording sheet supplying section 12, an image forming section 14, a position adjusting sectiond 15, a surface treatment section 16, and a cutting/arranging section 18. Various members arranged in commonly known printers as exemplified by means for conveying the recording sheet A (such as a conveying roller pair and a guide member) and a sensor for detecting the recording sheet A are also disposed as necessary in these sections or between the adjacent sections, although they are not specifically shown or denoted by reference numerals.

The printer 10 records images corresponding to a print size of prints to be outputted on the recording sheet A and cuts it into the print size to obtain the (finished) prints. In the illustrated preferable embodiment, so-called multiple image formation in which two, four or more images are allocated and formed on the recording sheet A is carried out as necessary, after which the recording sheet A is cut into the print size to produce prints from the recording sheet A.

In the printer 10, it is preferable to form images on the recording sheet A whose periphery (including the forward and rear ends in the conveying direction and both the lateral ends in a direction orthogonal to the conveying direction) is blank in order to prevent the apparatus from being contaminated by unfixed toner or the like. When the multiple image formation is carried out, it does not matter whether spaces are formed between the adjacent images or not.

In the following description, for convenience sake, the direction orthogonal to the conveying direction will be referred to as the “width direction” and the size of the recording sheet A in this direction will be referred to as the “width”. The conveying direction of the recording sheet A will be referred to as the “conveying direction” and the size of the recording sheet A in the conveying direction will be referred to as the “length”. Further, the forward end and the rear end are determined with respect to the conveying direction.

The recording sheet supplying section 12 (hereinafter referred to as the “supplying section 12”) is a portion for supplying the cut recording sheet A to the image forming section 14.

In the illustrated embodiment, the supplying section 12 includes two loading units into which magazines 20 each accommodating a recording sheet roll 20a of the elongated recording sheet A is loaded, and a loading unit into which a cassette 24 accommodating the cut recording sheets A is loaded.

The loading units for the magazines 20 usually accommodate the recording sheet rolls 20a whose widths or sizes are different from each other. On the other hand, the cassette 24 is a case as used in various printers, which is loaded into the printer after accommodating the recording sheets A.

The recording sheet A is not specifically limited and all kinds of recording sheet or image receiving medium used in a printer adopting an electrophotographic system is usable.

In the printer 10 according to the present invention, a recording sheet on which a highly glossy print of photographic quality can be produced (hereinafter also referred to as the sheet for producing a print of photographic image quality), such as a recording sheet obtained by forming a transparent resin layer made of a thermoplastic resin on a surface of a substrate made of paper or the like, is particularly suitable. For example, this recording sheet can be used to produce a highly glossy print like a silver halide photographic print by forming a toner image on the image forming surface of the transparent resin layer, applying heat and pressure to the transparent resin layer with a belt having an excellent surface smoothness to melt, and cooling and solidifying the transparent resin layer thereby transferring the surface properties of the belt (the toner image may be optionally fixed) (see JP 2004-109860 A and JP 05-216322 A).

The thermoplastic resin that may be used for the transparent resin layer is not specifically limited but preferred examples thereof include polyester, polyethylene, and styrene-acrylic ester resin. The thickness of the transparent resin layer is also not specifically limited but it is preferable that the layer thickness be in a range of 5 to 20 μm in order to prevent strain under stress (bending strain) from causing breakage (cracking) after the surface treatment.

Although not illustrated, each loading unit includes size detecting means for detecting the width (i.e. size) of the recording sheet roll 20a accommodated in the magazine 20, the size of the recording sheet A accommodated in the cassette 24, the kind of the recording sheet A (for example, whether the recording sheet A is plain paper or the sheet for producing a print of photographic image quality) with a DIP switch, a barcode, or the like.

A drawing-out roller pair 22 and a cutter 28 are disposed downstream of each magazine 20 loaded into one of the loading units (i.e. downstream in the conveying direction of the recording sheet A).

The drawing-out roller pair 22 is a roller pair with which the recording sheet is drawn out of the recording sheet roll 20a accommodated in the magazine 20. The cutter 28 is known means for cutting sheets such as a guillotine cutter.

The drawing-out roller pair 22 stops drawing out the recording sheet from the recording sheet roll 20a when the recording sheet on the downstream side of the cutter 28 has a predetermined length. Next, the cutter 28 cuts the recording sheet into a predetermined size and the thus cut recording sheet A is supplied to predetermined conveying means.

The recording sheet A accommodated in the cassette 24 is drawn out by known means used in various printers and is supplied to predetermined conveying means.

The recording sheet A cut into the predetermined size with the cutter 28 and the recording sheet A drawn out of the cassette 24 are both conveyed to the image forming section 14 through conveying roller pairs.

A printing head 26 for back printing on the back surface (i.e. non-image-recording surface) of the recording sheet is disposed between two conveying roller pairs immediately upstream of the image forming section 14.

The printing head 26 is not specifically limited and various known printing means such as an impact printer using an ink ribbon and an ink jet printer are usable.

The image forming section 14 is a portion where images are formed on the recording sheet A by electrophotography and includes an exposing subsection 30, a toner image forming subsection 32, a transferring subsection 34, a primary fixing roller pair 36, and a reversing subsection 40.

The exposing subsection 30 includes an exposure controller 42 and an exposing unit 44.

The exposure controller 42 acquires images (image data) to be reproduced on prints from an image supply source, carries out predetermined image processing, and performs an image layout in accordance with the number of images to be recorded on one recording sheet A, thereby preparing images to be recorded on the one recording sheet A.

On the other hand, the exposing unit 44 is a known light beam scanning optical system including a light source of a light beam (i.e. recording light) for exposing an electrophotographic photosensitive drum 46 of the toner image forming subsection 32 to be described later, a light deflector, an fθ lens, an optical path changing mirror, and a light beam adjusting lens.

That is, the exposing unit 44 deflects a light beam E modulated in accordance with image data (i.e. images to be recorded) supplied from the exposure controller 42 in a main scanning direction coinciding with the width direction (i.e. direction orthogonal to the conveying direction (in which the electrophotographic photosensitive drum 46 rotates). The deflected light beam E is emitted to and then reflected on a mirror 44a to be incident on the drum 46 at a predetermined exposure position, thereby recording a latent image on the electrophotographic photosensitive drum 46.

The toner image forming subsection 32 is a known device in which a toner image is formed by electrophotography and includes the electrophotographic photosensitive drum 46 (hereinafter referred to as the “photosensitive drum 46”), charging means 48, cleaning means 50, and toner supplying means 52.

The photosensitive drum 46 is a known electrophotographic photosensitive drum and is rotated in a direction indicated by an arrow “a” (i.e. direction opposite to the conveying direction of the recording sheet A) about a central axis coinciding with the width direction. As described above, the light beam E from the exposing unit 44 is deflected in the width direction, so the photosensitive drum 46 is two-dimensionally scanned by exposure to the light beam E modulated in accordance with the image to be recorded.

The toner supplying means 52 includes four toner supplying units that are a C (cyan) toner supplying unit 54C, an M (magenta) toner supplying unit 54M, a Y (yellow) toner supplying unit 54Y, and a K (black) toner supplying unit 54K, with the toner supplying units being attached to a rotatable drum-shaped main body 52a at intervals of a 90° rotation angle.

The transferring subsection 34 includes a transfer belt 60 that is an endless belt partially abutted against the photosensitive drum 46, three rollers 62 around which the transfer belt 60 is stretched, a press roller 64 which presses the transfer belt 60 outward against the photosensitive drum 46, a transfer roller 66, and a belt conveyor 68. The transfer belt 60 is an intermediate transfer member of the toner image and is rotated in a direction indicated by an arrow “b” (that is, the same direction as the direction in which the recording sheet A is conveyed). The transfer roller 66 is movable between the position at which the transfer belt 60 (i.e. recording sheet A) is nipped between the transfer roller 66 and one of the rollers 62, and the position at which the transfer roller 66 is spaced apart from the transfer belt 60.

While being rotated in the direction indicated by the arrow “a” in FIG. 1, the photosensitive drum 46 is uniformly charged in the width direction by the charging means 48 and is two-dimensionally scanned by exposure to the light beam E modulated in accordance with the image data as described above, thereby forming an electrostatic latent image. Next, the electrostatic latent image is developed by one of the toner supplying units of the toner supplying means 52, such as the Y toner supplying unit 54Y, which is positioned at the developing position (i.e. at the position facing the photosensitive drum 46) and a toner image such as a Y toner image is formed on the surface of the photosensitive drum 46.

The transfer belt 60 that partially contacts the photosensitive drum 46 and is pressed by the press roller 64 against the photosensitive drum 46 is rotated in the direction indicated by the arrow “b” in synchronization with the rotation of the photosensitive drum 46. Accordingly, the toner image on the photosensitive drum 46 developed by the toner supplying means 52 is transferred onto the transfer belt 60 in the contact portion (at which the press roller 64 presses the belt). After the toner image on the photosensitive drum 46 has been transferred onto the transfer belt 60, the cleaning means 50 removes residual toner from the photosensitive drum 46.

In the illustrated embodiment, formation of toner images and their transfer onto the transfer belt 60 are performed by sequentially actuating the four toner supplying units including the Y toner supplying unit 54Y, the M toner supplying unit 54M, the C toner supplying unit 54C, and the K toner supplying unit 54K.

For instance, after the Y toner image has been transferred onto the transfer belt 60 in the manner described above, the toner supplying means 52 (more specifically its main body 52a) is rotated by 90° in the direction of the arrow “a” to set the M toner supplying unit 54M at the developing position. After positioning on the transfer belt 60 of an M toner image to be transferred thereon, a latent image is formed on the photosensitive drum 46 and is developed to obtain the M toner image, which is then transferred onto the transfer belt 60. Subsequently, a C toner image and a K toner image are transferred onto the transfer belt in succession in the manner as described above. During this operation, the transfer roller 66 is spaced apart from the transfer belt 60.

Accordingly, in the illustrated embodiment, the Y, M, C, and K toner images are formed on the surface of the transfer belt 60 after positioning. In other words, a four-color (that is, a full-color) image is formed.

On the other hand, the recording sheet A cut into a predetermined size is supplied from the supplying section 12 and is placed under a standby state, for example, at a registration roller pair 70 immediately upstream of the transfer roller 66.

When a color image has been formed on the transfer belt 60, conveyance of the recording sheet A through the registration roller pair 70 is started in synchronization with the rotation of the transfer belt 60 so that the recording sheet A coincides in position with the color image formed on the transfer belt 60. In addition, the transfer roller 66 is pressed against the transfer belt 60 (roller 62) and the recording sheet A is conveyed while being nipped between the transfer belt 60 and the transfer roller 66. As a result of conveyance of the nipped recording sheet, four-color toner images formed on the surface of the transfer belt 60 are transferred onto the recording sheet A and an image is formed on the surface of the recording sheet A.

As described above, the recording sheet includes plural images allocated in accordance with the number of images to be recorded.

The recording sheet A on which the image has been formed is conveyed on the belt conveyor 68 to the primary fixing roller pair 36.

The primary fixing roller pair 36 is a pair of conveying rollers, at least one of which is a heating roller. The primary fixing roller pair 36 may be moved as required by a method of vertically moving the roller on the image forming surface side so as to take the position in which the recording sheet A is nipped and the position in which it is released.

As in the case in which an image formed by common electrophotographic system is fixed, the primary fixing roller pair 36 nips and conveys the recording sheet A on which the toner images have been formed through image transfer in the transferring subsection 34, whereby the toner images are fixed by heating under pressure.

The image forming method used in the printer 10 according to the present invention is not limited to the electrophotographic image forming method as in the illustrated embodiment and any known image forming method is usable.

For instance, image recording methods implemented in various known printers (printing means) including a printer that has a heat development step and uses a thermally developable photosensitive material as the image receiving medium on which images are formed in the presence of an image forming solvent such as water; an ink jet printer; and a thermal printer using a thermal head are usable.

The reversing subsection 40 is a portion in which the recording sheet A on which images have been fixed by the primary fixing roller pair 36 are reversed to produce so-called double-sided prints.

In the illustrated embodiment, the reversing subsection 40 includes first switching means 72 disposed downstream of the primary fixing roller pair 36, a path 74 branching from the conveying path from the primary fixing roller pair 36, a kickback unit 76 provided downstream of the branching path 74, a return conveying path 78 that branches from the branching path 74 and the kickback unit 76 to return to the registration roller pair 70 upstream of the transferring subsection 34, and second switching means 80 provided at the branch point between the kickback unit 76 and the return conveying path 78.

The first switching means 72 and the second switching means 80 are each known means for switching the sheet conveying path such as a flapper that acts on the conveying path (or is inserted in the conveying path) to guide the recording sheet A to a predetermined conveying path.

When a double-sided print is produced in the printer 10, the first switching means 72 is caused to act on the conveying path from the primary fixing roller pair 36 to convey the recording sheet A on which an image has been fixed by the primary fixing roller pair 36 to the branching path 74, from which the recording sheet A is conveyed to the kickback unit 76. Then, when the upstream end of the recording sheet A has reached the downstream side of the second switching means 80, the conveyance is stopped.

Next, the second switching means 80 is caused to act on the kickback unit 76 to change the conveying direction at the kickback unit 76 and the recording sheet A is conveyed to the return conveying path 78 in a direction opposite to the above direction while guided by the second switching means 80 and is further conveyed from the return conveying path 78 to the registration roller pair 70. In this manner, the front surface and the rear surface of the recording sheet are reversed.

The reversing subsection 40 may be provided by branching the conveying path from the downstream of the surface treatment section 16 in stead of branching it from the downstream of the primary fixing roller pair 36 (primary fixing unit).

The recording sheet A having the image fixed by the primary fixing roller pair 36 is then conveyed to the position adjusting section 15 and subsequently conveyed to the surface treatment section 16.

The position adjusting section 15 is a portion for changing the position in the width direction of the recording sheet A to be supplied to the surface treatment section 16, for example, for each order by moving in the width direction as required the recording sheet A on which images have been formed in the image forming section 14.

The surface treatment section 16 performs surface treatment for imparting glossiness in which the recording sheet A is pressed against an endless-belt-shaped surface treatment belt 88 while being heated, thereby being made to slightly stick to the surface treatment belt 88, then is cooled while being conveyed on the surface treatment belt 88, and is peeled off the surface treatment belt 88. This will be described in detail later.

In the area of the surface treatment belt 88 against which the recording sheet A is abutted, foreign matter is transferred onto the recording sheet A each time the recording sheet A is abutted against the surface treatment belt 88, so no foreign matter is deposited. Further, in this area, the amount of the foreign matter transferred onto the recording sheet A is very small, so the transferred foreign matter does not cause lowering of the print quality such as unevenness in glossiness.

In the area of the surface treatment belt 88 that does not contact the recording sheet A, however, foreign matter having adhered to the belt 88 accumulates. As described above, when foreign matter accumulates on the surface treatment belt 88, appropriate surface treatment cannot be performed, which leads to lowering of the print quality such as unevenness of glossiness.

In addition, as described above, when the recording sheet A contacts only a specified area of the surface treatment belt 88, degradation of the surface treatment belt 88 progresses only in the specified area in which the recording sheet A contacts the belt and, in particular, damage occurs at specified positions at which edges (end portions) of the recording sheet contact the belt 88.

In order to solve such an inconvenience, the position adjusting section 15 moves the recording sheet A bearing formed images in the width direction as necessary, thereby preventing the recording sheet A from contacting only a specified area of the surface treatment belt 88.

In other words, in the position adjusting section 15, for instance, processing in which the recording sheet A is supplied to the surface treatment section 16 as it is without moving the recording sheet A in the width direction and processing in which the recording sheet A is moved to a predetermined position in the width direction are alternately performed for each order (or for each predetermined number of orders). The position in the width direction of the recording sheet A to be supplied to the surface treatment section 16 is thus changed, for example, for each order, which makes it-possible to prevent accumulation of foreign matter at a specified position on the surface treatment belt 88, and damage to the surface treatment belt 88 due to contact of the edges of the recording sheet A with specified spots.

The change of the position in the width direction of the recording sheet A is not restrictively performed on an order unit basis but various methods can be used, as exemplified by a method in which the position in the width direction of the recording sheet A is changed each time a predetermined number of sheets passes therethrough, or each time a predetermined period of time elapses.

Plural changing modes including changing on an order basis, changing on a sheet number basis and changing on a lapsed time basis may be provided so that an appropriate changing mode can be selected and its changing timing can be set. Alternatively, two or more changing modes may be used in combination. For example, the position may be changed in the width direction also when sheets exceeding a predetermined number have passed through the position adjusting section 15 during the processing in one order, although the position change is basically performed on an order basis.

The position change of the recording sheet A in the width direction is not limited to the above case including the state in which the sheet is not moved in the width direction, and all the recording sheets A may be moved in the width direction.

As to the movement of the recording sheet A in the width direction, assuming, for example; that the position to which the recording sheet A is conveyed (i.e., the position at which the recording sheet A is located in the case where the sheet is not moved in the width direction in the position adjusting section 15) is a reference position, the recording sheet A may be moved only toward one of the right side and the left side in the width direction with respect to the reference position. Alternatively, the recording sheet A may be moved toward both of the right side and the left side in the width direction with respect to the reference position.

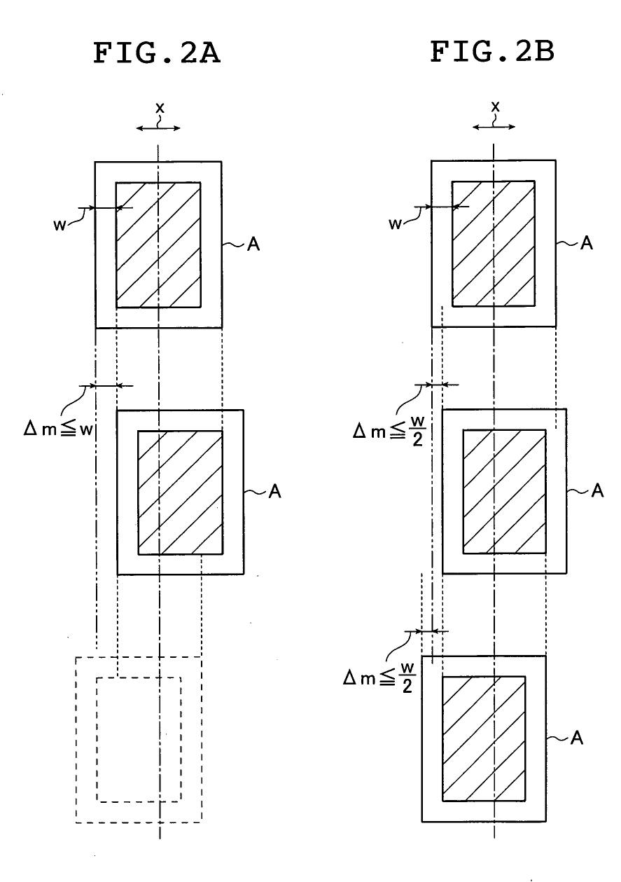

Further, the number of the positions in the width direction to be adjusted in the position adjusting section 15 (including the reference position) is not limited to two as in the case shown in FIG. 2A to be described later or three as in the case shown in FIG. 2B also to be described later, and four or more positions in the width direction may be set to change the position of the recording sheet A in the width direction.

The amount of movement of the recording sheet A moved in the width direction in the position adjusting section 15 is not specifically limited.

However, if the amount of movement of the recording sheet A moved in the width direction in the position adjusting section 15 is inappropriate, foreign matter having accumulated on the surface treatment belt 88 of the surface treatment section 16 is positioned within the image area (i.e. print area) of the recording sheet A to be subsequently subjected to surface treatment as a result of the position change of the recording sheet A in the width direction made for the next order or after the passage of a predetermined number of sheets therethrough. Consequently, unevenness of glossiness, adhesion of the foreign matter to the recording sheet A, or the like occurs, which causes lowering of the quality of the prints obtained.

When the amount of movement in the width direction in the position adjusting section 15 is increased, the moving area in the width direction of a slitter in the cutting subsection 102 to be described later is accordingly increased, which increases the size and cost of the cutting subsection 102.

In order to prevent the above-mentioned inconvenience, it is preferable that the amount of movement of the recording sheet A in the width direction be set to be equal to or smaller than the width of each end portion in the width direction of the recording sheet A cut in the cutting subsection 102 when the recording sheet A is moved only on one side in the width direction with respect to the reference position, and be set to be not more than half the width of the cut end portion when the recording sheet A is moved on both sides in the width direction with respect to the reference position.

That is, when the width of the end portions in the width direction (i.e. direction indicated by an arrow “x” in FIGS. 2A and 2B) of the recording sheet A cut in the cutting subsection 102 is referred to as “w” and the amount of movement of the recording sheet A moved in the width direction in the position adjusting section 15 is referred to as “Δm” as shown in FIGS. 2A and 2B, it is preferable that “Δm≦w” be satisfied when the recording sheet A is-moved only on one side in the width direction and “Δm≦w/2” be satisfied when the recording sheet A is moved on both sides in the width direction.

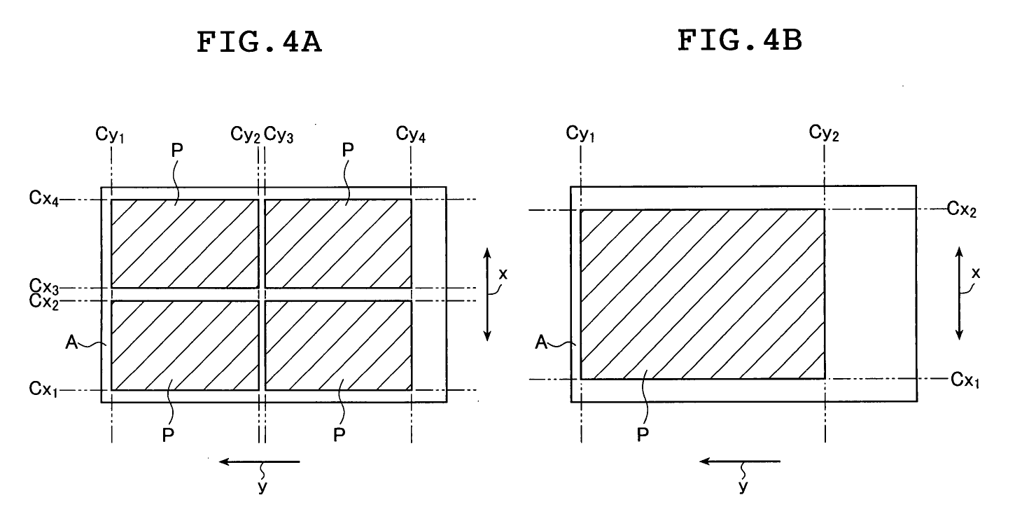

The width w of the cut end portions in the width direction of the recording sheet A is a width between a cutting line Cx₁ and an end portion on the same side of the recording sheet A and a width between a cutting line Cx₄ and an end portion on the same side of the recording sheet A in an example shown in FIG. 4A to be described later and is a width between a cutting line Cx₁ and an end portion on the same side of the recording sheet A and a width between a cutting line Cx₂ and an end portion on the same side of the recording sheet A in an example shown in FIG. 4B.

As described above, the surface treatment section 16 performs surface treatment by pressing the recording sheet A against the surface treatment belt 88 as it is heated thereby making the sheet slightly stick to the surface treatment belt 88, cooling the recording sheet A as it is conveyed on the surface treatment belt 88, and peeling the recording sheet A off the surface treatment belt 88.

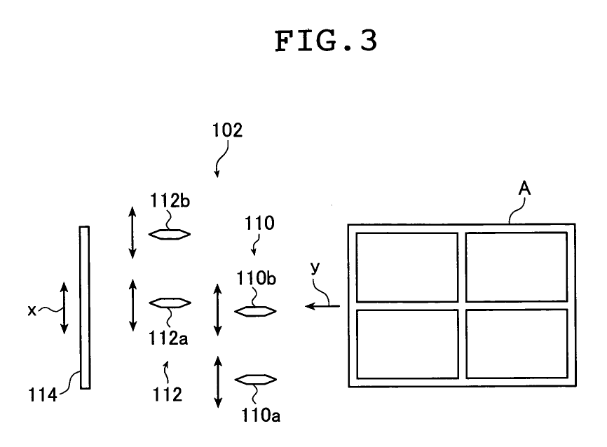

In the cutting subsection 102 of the printer 10, the recording sheet A is cut along the conveying direction with a first slitter 110 and optionally a second slitter 112 into a width corresponding to the print size of prints to be produced. Thereafter, the thus cut recording sheet A is cut in the width direction with the guillotine cutter 114 into the print size of the prints to be produced. This will be described in detail later with reference to FIGS. 3, 4A and 4B.

In view of the above, when the recording sheet A is moved in the position adjusting section 15 only on one side in the width direction (right side on the paper plane of FIG. 2A) with respect to the reference position (see the uppermost sheet) as shown in FIG. 2A, it is preferable that the amount of movement Am of the recording sheet A moved in the width direction in the position adjusting section 15 be set to be equal to or less than the width w of the sheet cut in the cutting subsection 102 (Δm≦w) and it is particularly preferable that “Δm≈w” and “Δm≦w” be satisfied.

With this construction, the area outside edge portions in the width direction (edge positions in the width direction) of the recording sheet A taking the reference position is not positioned within the diagonally shaded print area of the recording sheet A taking the movement position, and vice versa. In other words, the print area of the recording sheet A taking the reference position is positioned within the moved recording sheets A and that of the moved recording sheet A is positioned within the recording sheet A taking the reference position. Accordingly, even when foreign matter accumulating on the surface treatment belt 88 of the surface treatment section 16 in a portion corresponding to the vicinity of the edge portion of one recording sheet A is transferred to another recording sheet A differing in position, or unevenness of glossiness occurs to the recording sheet A, there is no adverse effect on the quality of a print P because this area is later cut out with the slitter of the cutting subsection 102. On the other hand, the area of the surface treatment belt 88 corresponding to the other edge portion of the recording sheet A is cleaned by the recording sheet A whose position has been changed. This construction is also preferable in order to protect against dirt the recording sheet A whose position has been changed. The cutting subsection 102 can be prevented from being upsized.

The same effect is achieved regardless of toward which side in the width direction the recording sheet A is moved with respect to the reference position. Accordingly, even when the recording sheet A is moved on both sides in the width direction with respect to the reference position by setting the amount of movement Δm at the cutting width w, the print area of the recording sheet A at the reference position and the edge portions of the recording sheet A at another position do not overlap each other in the width direction.

However, when the recording sheet A is moved on both sides in the width direction with respect to the reference position by setting the amount of movement Δm at the cutting width w, an edge portion of a moved recording sheet A is positioned within the print area of another moved recording sheet A as-shown by dotted lines in the lower part of FIG. 2A. As a result, when the surface treatment is performed in the surface treatment section 16, foreign matter accumulating on the surface treatment belt 88 in portions corresponding to the vicinity of the edge portion of one recording sheet A adheres to the print area of another recording sheet A, which causes quality degradation such as unevenness of glossiness.

Therefore, when the recording sheet A is moved in the position adjusting section 15 on both sides in the width direction with respect to the reference position, it is preferable that, as shown in FIG. 2B, the amount of movement Δm in the width direction of the recording sheet A be set to be not more than half the width W of the end portions in the width direction cut in the cutting subsection 102 (i.e. Δm≦w/2) and it is particularly preferable that “Δm≈w/2” and “Δm≦w/2” be satisfied.

With this construction, as shown in FIG. 2B, the area outside the edge portions in the width direction of a recording sheet A at a position at which it is moved in the width direction is not positioned within the print areas of other recording sheets A at different positions. Accordingly, there is no quality degradation due to foreign matter accumulating in proximity to the edge portions of the recording sheet A as in the example described above and the present invention is advantageous also in terms of cleaning of areas of the surface treatment belt 88 in proximity to the edge portions of the recording sheet A.

When the cutting width w is changed in accordance with the number of images to be formed on the recording sheet A and the positions of the images (i.e. imposition state) on the recording sheet A, even if the recording sheet A has the same size (width), the amount of movement must be determined with reference to the minimum cutting width w of the end portions in the width direction of the recording sheet A of this size. In this regard, the same applies even when the cutting widths of both the end portions in the width direction of the recording sheet A differ from each other.

In the printer 10 according to the present invention, in order to lengthen the service life of the surface treatment belt 88, the position adjustment in which the movement only on one side in the width direction with respect to the reference position is performed by satisfying “Δm≦w” and the position adjustment in which the movement on both sides in the width direction with respect to the reference position is performed by satisfying “Δm≦w/2” may be performed automatically at predetermined timings set depending on the number of orders, the number of recording sheets A processed, or the like and/or both of the position adjustments may be set as selectable modes.

Moving means (position adjusting means) used in the position adjusting section 15 for moving the recording sheet A in the width direction is not specifically limited and various known means for moving sheets are usable.

Examples of the moving means include: moving means using pressing means for pressing the recording sheet A in the width direction; moving means for setting the position in the width direction at a predetermined position using a guide member that performs positional regulation through its contact with the edges (end portions in the width direction) of the recording sheet A and is capable of position change in the width direction; moving means using a conveying roller pair for moving the nipped recording sheet A in the axial direction; and moving means in which the recording sheet A is held by holding means such as a suction cup, the holding means is then moved in the width direction and the recording sheet A is released from the holding means.

Information about the position adjustment of the recording sheet A performed in the position adjusting section 15, in other words, information about whether or not the recording sheet A is moved, information about the amount of movement Δm at the time of the sheet movement and optionally information about the direction of the sheet movement (in the case where the recording sheet A is moved on both sides with respect to the reference position) are sent to the cutting subsection 102 to be described later (and optionally an arranging subsection 104).

The recording sheet A that was moved as required in the width direction in the position adjusting section 15 to a predetermined position in the width direction in the manner described above is then conveyed to the surface treatment section 16 located downstream.

The surface treatment section 16 performs surface treatment of the recording sheet A (and optionally secondary fixation of the toner image) when the above-mentioned sheet for producing a print of photographic image quality is used for the recording sheet A to produce a high-quality print having glossiness equivalent to that of a silver halide photographic print. To be more specific, the recording sheet A is surface-treated as follows: The surface (image forming surface) of the recording sheet A is abutted and pressed against the belt-shaped surface treatment means to be heated and is then cooled.

Usually, print production using plain paper does not require the surface treatment and the fixing treatment in the surface treatment section 16, so the recording sheet A is passed through the surface treatment section 16 without any treatment. Alternatively, when no cutting operation is required in the subsequent cutting/arranging section 18, the recording sheet may be outputted to a predetermined tray as a print immediately after the fixation by the primary fixing roller pair 36 has been finished.

In the present invention, however, if necessary, the surface treatment described below may be carried out not only on the sheet for producing a print of photographic image quality but also on various other recording sheets A such as plain paper.

In the illustrated embodiment, the surface treatment section 16 includes a heating roller 85, a roller 86, the surface treatment belt 88 that is an endless belt stretched around the heating roller 85 and the roller 86, a cooling unit 90, and a nip roller 92.

The surface treatment belt 88 is a belt that serves as the surface treatment means in the present invention and is a belt that is extremely high in surface (outer surface) smoothness. The heating roller 85 is a heating roller that generates heat to a temperature appropriate for heating the recording sheet A. The cooling unit 90 cools the surface treatment belt 88 by abutting the cooling unit 90 against the inner surface of the surface treatment belt 88 so that the recording sheet A being conveyed on the surface treatment belt 88 is cooled. Further, the nip roller 92 is abutted and pressed against the surface treatment belt 88 at the position corresponding to the heating roller 85, whereby the recording sheet A is pressed against the surface treatment belt 88 and is conveyed on the surface treatment belt 88 while being nipped between the roller 92 and the belt 88.

The heating means in the heating roller 85 and the cooling means in the cooling unit 90 are not specifically limited and any known means is usable.

As is apparent from FIG. 1, the recording sheet A having an image fixed thereon is conveyed to the surface treatment section 16 with the image forming surface facing the surface treatment belt 88.

In the surface treatment section 16, first, the recording sheet A is conveyed while being nipped between the surface treatment belt 88 (heating roller 85) and the nip roller 92, thereby abutting and pressing a surface of the recording sheet A (surface of the transparent resin layer of the sheet for producing a print of photographic image quality) against a surface of the surface treatment belt 88 and heating the recording sheet A with the heating roller 85.

As a result of the heating/pressing, the transparent resin layer is melted to make the recording sheet A slightly stick to the surface treatment belt 88, and the recording sheet A is conveyed in this state on the surface treatment belt 88. In the surface treatment section 16, the cooling unit 90 cools the recording sheet A during its conveyance to solidify the melted transparent resin layer.

The thus cooled recording sheet A is peeled off the surface treatment belt 88 at the portion at which the surface treatment belt 88 turns around the roller 86 and is then supplied downstream.

In this manner, the transparent resin layer (thermoplastic resin) on the surface of the recording sheet A is pressed against the surface treatment belt 88 to be heated/melted and then is cooled/solidified as it is conveyed. As a result, the surface properties of the surface treatment belt 88 are transferred onto the transparent resin layer. As described above, the surface treatment belt 88 has extremely high surface smoothness. Therefore, the recording sheet A onto which the surface properties of the surface treatment belt 88 have been transferred becomes a sheet having high surface smoothness and favorable glossiness, whereby a print whose quality is as high as that of a silver halide photographic print can be obtained.

In the surface treatment of the recording sheet A, not only such a treatment for imparting glossiness but also various other surface treatments including matting (graining) can be performed by selecting the surface properties of the surface treatment belt 88.

As described above, the printer 10 changes the position in the width direction of the recording sheet A in the position adjusting section 15, for example, for each order. Therefore, the following defects can be prevented: The recording sheet A is only abutted against a specified area of the surface treatment belt 88 to deteriorate only this area; the edges of the recording sheet A are abutted against the surface treatment belt 88 at their specified positions to damage the surface treatment belt 88; and foreign matter accumulates in proximity to the edges of the recording sheet A.

In the illustrated printer 10, the heating and cooling conditions used in the surface treatment section 16 may be made adjustable so that the glossiness or other property to be imparted to the surface of the recording sheet A (print) can be adjusted.

In the illustrated embodiment, the recording sheet A is peeled off the surface treatment belt 88 by utilizing so-called stiffness of the recording sheet A. Accordingly, the peelability of the recording sheet A from the surface treatment belt 88 can be improved preferabiy by reducing, as shown in FIG. 1, the diameter of the roller 86 which is located at the position at which the recording sheet A is discharged from the surface treatment section 16 and around which the surface treatment belt 88 is stretched.

The recording sheet A having undergone the surface treatment in the surface treatment section 16 is then conveyed to the cutting subsection 102 of the cutting/arranging section 18.

The cutting/arranging section 18 includes the cutting subsection 102, the arranging subsection 104, and a discharging subsection 106.

The recording sheet A that was conveyed to the cutting/arranging section 18 after having undergone the surface treatment (for imparting glossiness) in the surface treatment section 16 is first cut in the cutting subsection 102 into a print size whereby prints P (i.e. hard copies) to be outputted as products are obtained.

The cutting subsection 102 includes the first slitter 110, the second slitter 112, the guillotine cutter 114, and a registration roller pair 116.

Each of the first slitter 110 and the second slitter 112 is a member for cutting the recording sheet A in the conveying direction and is a known slitter using, for example, a rotary cutter or a circular cutter. The second slitter 112 is disposed downstream of the first slitter 110.

As shown in FIG. 3 as a schematic plan view of the cutting subsection 102 in which the registration roller pair 116 is not shown, the first slitter 110 and the second slitter 112 each include two cutters which are arranged side by side in the width direction (i.e. direction of the arrow “x” in FIG. 3) at the same position in the conveying direction. To be more specific, the first slitter 110 includes cutters 110a and 110b and the second slitter 112 includes cutters 112a and 112b.

Also, each cutter constituting each slitter is made movable in the width direction with a known method.

Each of the first slitter 110 and the second slitter 112 moves its respective cutters in the width direction to positions corresponding to prints to be produced in accordance with information about the width of the recording sheet A, information about the positions of images (i.e. information about the positions in the width direction), and information about the position adjustment of the recording sheet A in the position adjusting section 15.

In the cutting subsection 102, after the respective cutters of the first slitter 110 and the second slitter 112 have been thus set at the cutting positions in the width direction, the recording sheet A is conveyed and cut in the conveying direction (i.e. direction of an arrow “y” in FIG. 3) into a size in the width direction of the prints to be produced.

The printer 10 records up to two images (i.e. performs imposition of up to two images) side by side in the width direction, for instance.

As shown in FIGS. 3 and 4A, when two images have been recorded side by side in the width direction, the cutter 110a of the first slitter 110 is set at the position of a cutting line Cx₁ of an image on the left side in the width direction (indicated by the arrow “x”) which extends in the conveying direction (indicated by the arrow “y”) and the cutter 110b of the first slitter 110 is set at the position of a cutting line Cx₂ of the left-side image. Further, the cutter 112a of the second slitter 112 is set at the position of a cutting line Cx₃ of an image on the right side in the width direction and the cutter 112b of the second slitter 112 is set at the position of a cutting line Cx₄ of the right-side image.

In the cutting subsection 102, when two images have been recorded side by side in the width direction, while the recording sheet A is conveyed in the state described above, the first slitter 110 cuts the recording sheet A in the conveying direction into the size in the width direction of a print on which the left-side image has been reproduced, before the second slitter 112 cuts the recording sheet A into the size in the width direction of a print on which the right-side image has been reproduced.

On the other hand, when one image has been recorded in the width direction as shown in FIG. 4B, the second slitter 112 (i.e. cutters 112a and 112b) is retracted from the conveying path of the recording sheet A, the cutter 110a of the first slitter 110 is set at the position of the cutting line Cx₁, and the cutter 110b of the first slitter 110 is set at the position of the cutting line Cx₂.

In the cutting subsection 102, when one image has been recorded in the width direction, while the recording sheet A is conveyed in the state described above, the first slitter 110 cuts the recording sheet A into the size in the width direction of a print on which the image has been reproduced.

In the cutting subsection 102, the cutting position is basically determined in accordance with information about the size of the recording sheet A and positional information in forming images in the image forming section 14. However, as described above, the position adjusting section 15 of the printer 10 adjusts the position in the width direction of the recording sheet A, for example, for each order.

Accordingly, when the cutting position is set only with reference to the information about the size of the recording sheet A and the information about the image forming position, the recording sheet A that has been moved in the width direction cannot be cut at a position proper to the image, although the recording sheet A that has not been moved in the width direction but remains at the reference position can be properly cut.

In order to solve this problem, the cutting subsection 102 of the illustrated printer 10 adjusts the positions at which the first slitter 110 and optionally the second slitter 112 perform cutting in accordance with the information about the position adjustment of the recording sheet A obtained from the position adjusting section 15, in other words, the information about whether or not the recording sheet A is moved in the width direction and the information about the amount of movement Δm at the time of the sheet movement and optionally the information about the sheet moving direction.

More specifically, the cutting subsection 102 determines from the information about the position adjustment whether or not the recording sheet A has been moved in the position adjusting section 15. Next, when the recording sheet A has been moved in the width direction in the position adjusting section 15, the cutting subsection 102 moves the cutting positions at which cutting is made by the first slitter 110 and optionally the second slitter 112 (i.e. positions of the respective cutters) by Δm from the cutting positions in the recording sheet A at the reference position toward the direction in which the recording sheet A has been moved in the position adjusting section 15 in accordance with the information about the amount of movement Δm and optionally the information about the sheet moving direction. Then, the cutting subsection 102 cuts the recording sheet A in the conveying direction.

The printer 10 having the above construction is capable of properly cutting the recording sheet A even if a portion for readjusting the position in the width direction of the recording sheet A and moving means for moving the cutting subsection 102 in the width direction are not provided for the steps subsequent to the surface treatment in the surface treatment section 16 in the apparatus in which the position in the width direction of the recording sheet A to be supplied to the surface treatment section 16 is changed, for example, for each order in order to protect the surface treatment belt 88 against partial damage and partial accumulation of foreign matter. Therefore, increases in size and cost can be prevented.

The guillotine cutter 114 is a known guillotine cutter with which the recoding sheet A is cut in the width direction.

The registration roller pair 116 is a conveying roller pair with which the conveyance of the recording sheet A is stopped at the position at which the recording sheet A is to be cut by the guillotine cutter 114 in accordance with the information about the image position on the recording sheet A (information about the position in the conveying direction), in other words, the cutting position in the conveying direction of the recording sheet A is determined.

For instance, in the case where two images have been recorded side by side in the conveying direction as shown in FIG. 4A, the registration roller pair 116 first stops the conveyance of the recording sheet A when a cutting line Cy₁ at the forward ends of images on the forward side of the sheet has reached the position at which the sheet is cut by the guillotine cutter 114. Next, the guillotine cutter 114 is actuated to cut the recording sheet A along the cutting line Cy₁.

After the cutting, the registration roller pair 116 resumes the conveyance of the recording sheet A and stops the conveyance of the recording sheet A when a cutting line Cy₂ at the rear ends of the forward images has reached the position at which the sheet is cut by the guillotine cutter 114. Next, as in the above, the guillotine cutter 114 is actuated to cut the recording sheet A along the cutting line Cy₂. The recording sheet A has been cut in advance by the first slitter 110 and the second slitter 112 of the cutting subsection 102 along the cutting line Cx₁ to the cutting line Cx₄, so two prints P on the forward side are cut out by the guillotine cutter 114.

Then, the same procedure is repeated. More specifically, after the cutting, the registration roller pair 116 resumes the conveyance of the recording sheet A and stops the conveyance when a cutting line Cy₃ at the forward ends of the following images in the conveying direction has reached the position at which the sheet is cut by the guillotine cutter 114, after which the guillotine cutter 114 cuts the recording sheet A along the cutting line Cy₃. Then, the registration roller pair 116 resumes the conveyance and stops the conveyance when a cutting line Cy₄ at the rear ends of the following images has reached the cutting position, after which the guillotine cutter 114 cuts the recording sheet A along the cutting line Cy₄.

As a result of the cutting operation along the cutting line Cy₃ and the cutting line Cy₄ as well as the cutting operation along the cutting line Cx₁ to the cutting line CX₄, two prints P on the rear side are cut out as in the case of the two prints P on the forward side. Consequently, four prints P each of which corresponds to a print size and bears one of four images recorded on the recording sheet A are cut out.

On the other hand, in the case where one image has been recorded in the conveying direction as shown in FIG. 4B, the registration roller pair 116 stops the conveyance of the recording sheet A when a cutting line Cy₁ at the forward end of the image has reached the position at which the sheet is cut by the guillotine cutter 114. Then, the guillotine cutter 114 is actuated to cut the recording sheet A along the cutting line Cy₁.

After the cutting, the registration roller pair 116 resumes the conveyance of the recording sheet A and stops the conveyance of the recording sheet A when a cutting line Cy₂ at the rear end of the image has reached the position at which the sheet is cut by the guillotine cutter 114. Then, as in the above, the guillotine cutter 114 is actuated to cut the recording sheet A along the cutting line Cy₂. As described above, the recording sheet A has been cut in advance by the first slitter 110 of the cutting subsection 102 along the cutting line Cx₁ and the cutting line Cx₂, so one print corresponding to a print size and bearing the image recorded on the recording sheet A is cut out as a result of the cutting operation with the guillotine cutter 114.

Each print P cut in the cutting subsection 102 (or cut out from the recording sheet A) is then conveyed to the arranging subsection 104 and is further conveyed from the arranging subsection 104 to the discharging subsection 106.

The arranging subsection 104 discharges each print P cut in the cutting subsection 102 to the discharging subsection 106. When two images have been recorded side by side in the width direction on the recording sheet A, the arranging subsection 104 unifies two lines of prints P that have been obtained in the width direction through cutting in the cutting subsection 102 into one line (or the print lines are unified) and discharges the unified prints P to the discharging subsection 106. In the illustrated embodiment, the arranging subsection 104 includes an introducing roller unit 120, conveying roller pairs 122, 124, and 130, a discharging roller pair 126, and a line unifying roller pair 132.

The discharging subsection 106 is a belt conveyor including two rollers 140 and an endless belt 142 stretched around the rollers 140.

The introducing roller unit 120 of the arranging subsection 104 includes two roller pairs 120a and 120b that are arranged side by side in the width direction. The roller pairs 120a and 120b are each a pair of conveying rollers capable of being driven independently of each other.

In the case where two images have been recorded side by side in the width direction, the roller pair 120a that is one of the roller pairs of the introducing roller unit 120 serves to convey each print P (or is disposed at the position in the width direction of the print P) obtained through cutting with the first slitter 110 along the cutting line Cx₁ and the cutting line Cx₂; and the roller pair 120b that is the other of the roller pairs of the introducing roller unit 120 serves to convey each print P (or is disposed at the position in the width direction of the print P) obtained through cutting with the second slitter 112 along the cutting line Cx₃ and the cutting line Cx₄.

The arranging subsection 104 includes a lower first conveying path 134 which branches downstream of the introducing roller unit 120 and includes the conveying roller pairs 122 and 124, and an upper second conveying path 136 including the conveying roller pair 130 and the line unifying roller pair 132. The line unifying roller pair 132 of the second conveying path 136 is a conveying roller pair that is movable in the width direction. A guide member (not shown) which acts on the conveying path from the roller pair 120a and optionally the roller pair 120b to guide the prints P to the first conveying path 134 is disposed at the position at which the above conveying path branches out into the first and second conveying paths.

In addition, the conveying paths 134, 136 join downstream of the conveying roller pair 124 and the conveying roller pair 132 by means of a guide member (not shown) to reach the discharging roller pair 126.

When two images have been recorded side by side in the width direction as shown in FIG. 4A, the guide member is caused to act only on the conveying path from the roller pair 120a of the introducing roller unit 120.

Two lines of the cut prints P disposed in the width direction are conveyed to the arranging subsection 104, where the prints P cut by the first slitter 110 are conveyed to the first conveying path 134 by the roller pair 120a and the guide member and the prints P cut by the second slitter 112 are conveyed to the second conveying path 136 by the roller pair 120b.

The prints P conveyed to the first conveying path 134 are supplied through the conveying roller pairs 122 and 124 to the discharging roller pair 126, from which the prints e are then discharged to the discharging subsection 106.

On the other hand, when the conveyed print P has been nipped between the line unifying roller pair 132 of the second conveying path 136, the conveyance is stopped. Next, after the conveying roller pair 130 is placed in a released state as necessary, the line unifying roller pair 132 is moved in the width direction, thereby moving the print P to a position in the width direction corresponding to the roller pair 120a. After the movement in the width direction, the line unifying roller pair 132 and optionally the conveying roller pair 130 start conveying the print P in synchronization with the conveyance to the discharging roller pair 126 of the print P having been supplied to the first conveying path 134 so that each set of the prints P disposed side by side are sequentially conveyed to the discharging roller pair 126. Next, the discharging roller pair 126 discharges the print P to the discharging subsection 106.

In the example shown in FIG. 4A, two prints P have been formed side by side also in the conveying direction.

In this case, when the preceding print P has passed through the line unifying roller pair 132, the line unifying roller pair 132 is moved backward in the width direction to return to the original position. Next, the following print P is conveyed from the roller pair 120b to the second conveying path 136. As in the case described above, when the print P is nipped between the line unifying roller pair 132, the conveyance in the second conveying path 136 to which the print P has been conveyed is stopped and the conveying roller pair 130 is placed in the released state as necessary. Next, the line unifying roller pair 132 is moved in the width direction, thereby moving the print P to the position in the width direction corresponding to the roller pair 120a. Then, the print P is conveyed by the line unifying roller pair 132 and optionally the conveying roller pair 130 and then discharged to the discharging subsection 106 by the discharging roller pair 126.

As a result, two or more lines of prints P arranged in the width direction are unified into one line and then discharged to the discharging subsection 106.

There is also a case where, in the printer 10, panoramic-sized prints or other long-sized two prints are formed side by side in the width direction, that is, prints in a state where the two prints P arranged side by side in the conveying direction (indicated by the arrow “y”) in FIG. 4A are connected to each other are formed.

In this case, when the print P is nipped between the line unifying roller pair 132 in the second conveying path 136, the conveying roller pair 130 and optionally the roller pair 120b release the print P. Next, the line unifying roller pair 132 is moved in the width direction, thereby moving the print to the position in the width direction corresponding to the roller pair 120a. Following this, the print P is conveyed by the conveying roller pair 130 and the line unifying roller pair 132 while being nipped between the conveying roller pair 130 and optionally the roller pair 120b. The print P is then discharged to the discharging subsection 106 through the discharging roller pair 126.

This operation enables the panoramic-sized prints or other long-sized prints arranged in two or more lines to be advantageously unified into one line.

In contrast to this, when one image has been recorded in the width direction as shown in FIG. 4B, the guide member is caused to act on both of the conveying path from the roller pair 120a and the conveying path from the roller pair 120b.

When the cut print P is conveyed to the arranging subsection 104, the introducing roller unit 120 whose roller pairs 120a and 120b are driven in synchronism, and the guide member convey the print P to the first conveying path 134, where the print P is conveyed through the conveying roller pairs 122 and 124 to the discharging roller pair 126 and is then discharged to the discharging subsection 106 through the discharging roller pair 126.

The discharging subsection 106 receives the prints P conveyed through and discharged/dropped from the discharging roller pair 126 and stacks the prints P on the belt conveyor. Then, when it is confirmed based on sort information that prints for one order have been stacked thereon, the discharging subsection 106 conveys the stack of the prints P by a predetermined distance set in accordance with the print size (maximum print length in the processed order) and stops the conveyance. Then, the discharging subsection 106 receives the prints P for the next order:

As described above, the position adjusting section 15 of the illustrated printer 10 changes the position in the width direction of the recording sheet A, for example, for each order.

Therefore, the position in the width direction of the print P discharged to the discharging subsection 106 is different between the recording sheet A that took the reference position in the position adjusting section 15 and the recording sheet A that was moved in the width direction in the position adjusting section 15. Therefore, for example, the position in the width direction of the prints P stacked in the discharging subsection 106 varies for each order. Alternatively, in the case where the position in the width direction of the recording sheet A was changed in one order, the prints P stacked in the discharging subsection 106 for one order also vary in the position in the width direction.

In order to solve such an inconvenience, the following mechanism may be applied to the printer 10 of the present invention: A conveying roller pair movable in the width direction is used for the conveying roller pair 124 (or the conveying roller pair 122) in the first conveying path 134 of the arranging subsection 104. In this case, the position adjusting information is also supplied from the position adjusting section 15 described above to the arranging subsection 104 to adjust the positions of the prints P to be discharged to the discharging subsection 106 (or to be passed through the discharging roller pair 126) in the width direction so that all the prints coincide in position in the width direction with each other.

More specifically, it is determined based on the position adjusting information whether or not the recording sheet A has been moved in the width direction in the position adjusting section 15. In the case where the print P is obtained from the recording sheet A having been moved in the width direction in the position adjusting section 15, the print P is nipped between the conveying roller pair 124 and is then released as necessary from the conveying roller pair 122 to move the conveying roller pair 124 by Δm in the opposite direction to the direction of the recording sheet movement based on the information about the amount of movement Δm and optionally the information on the moving direction, whereby the thus moved print P is supplied to the discharging roller pair 126.

When the second conveying path 136 is used to unify the print lines into one line, as in the above, it is determined whether or not the recording sheet A has been moved in the width direction in the position adjusting section 15. As to the recording sheet A having been moved in the width direction, the amount of movement of the line unifying roller pair 132 is increased or decreased based on the information about the amount of movement Δm and optionally the information about the moving direction to unify print lines into one line, thereby supplying the prints P to the discharging roller pair 126.

Alternatively, the discharging roller pair 126 may be used as a conveying roller pair movable in the width direction. In this case, the discharging roller pair 126 is moved in the same manner by Δm in the opposite direction to the direction of the recording sheet movement so that all the prints P discharged to the discharging subsection 106 coincide in position in the width direction with each other.

As described above, the printer 10 in the illustrated embodiment includes two loading units into which the magazines 20 each accommodating the recording sheet roll 20a are loaded and the recording sheets A accommodated in the respective magazines 20 usually differ from each other in width.

When production of prints P using the recording sheet A having a smaller width is followed by that using the recording sheet A having a larger width in the printer 10, there is a high possibility that foreign matter accumulating on the surface treatment belt 88 in the surface treatment section 16 will be transferred onto the recording sheet A of a wider size or adversely affect the surface treatment, thus causing any degradation of the quality such as uneven glossiness.

Therefore, when the recording sheet A is changed from narrower one to wider one in the printer 10, it is preferable to compare the width of the region constituting the prints P in the wider recording sheet A (when there are two or more images in the width direction, the whole width covering all the images; hereinafter referred to as the print width) with the width of the narrower recording sheet A and perform processing based on the comparison results.

To be more specific, when it has been found as a result of the comparison that the width of the narrower recording sheet A is wider than the print width of the wider recording sheet A, the positional adjustment of the recording sheet A in the width direction that is performed by the position adjusting means 15 is controlled so that the print area of the wider recording sheet A does not exceed the width of the narrower recording sheet A.

Conversely, when the width of the narrower recording sheet A is narrower than the print width of the wider recording sheet A, before the print production with the wider recording sheet A is performed, one wider recording sheet A is passed as a dummy sheet on which no image is formed, is subjected only to the surface treatment in the surface treatment section 16 as usual, and is discharged to the discharging subsection 106.

With this construction, even in the case where the recording sheet A used is changed from the narrower one to the wider one, foreign matter accumulating on the surface treatment belt 88 can be prevented from being transferred onto the wider recording sheet A or adversely affecting the surface treatment, thus causing any degradation of the quality such as uneven glossiness.

In the printer 10 according to the present invention, there is no particular limitation on the processing for changing the recording sheet A from the wider one to the narrower one.

For instance, when the recording sheet A is changed from the narrower one to the wider one without performing the comparison described above, the same processing may be performed by passing one wider recording sheet A as a dummy sheet on which no image is formed, regardless of the width or print width of the recording sheet A.

The printer according to the present invention has been described in detail above. However, the present invention is not limited to the embodiments described above and it is of course possible to make various modifications and changes without departing from the gist of the present invention.

What is claimed is:

1. A printer comprising:
a surface treatment section which subjects an image recording medium to a surface treatment by conveying said image recording medium on a belt-shaped surface treatment means while said image recording-medium is abutted against said belt-shaped surface treatment means;
a position adjusting section which is disposed upstream of said surface treatment section, and moves said image recording medium in a width direction orthogonal to a conveying direction in said surface treatment section as necessary; and
a cutting section which is disposed downstream of said surface treatment section, adjusts a cutting position in said width direction in accordance with information about movement of said image recording medium in said position adjusting section, and cuts said image recording medium in accordance with a print size of a print to be outputted.

2. The printer according to claim 1, further comprising:
a line unifying section which is provided downstream of said cutting section and which, when said cutting section cut out prints in two or more lines in said width direction, moves said prints in said two or more lines to unify into one line in said conveying direction,
wherein said line unifying section adjusts an amount of movement of said prints in said width direction in accordance with information about movement of said image recording medium in said position adjusting section.

3. The printer according to claim 1, wherein said position adjusting section changes movement of said image recording medium in said width direction for each order, for each predetermined number of sheets of said image recording medium or for each elapsed time.

4. The printer according to claim 1, wherein said position adjusting section moves said image recording medium in said width direction only on one side in said width direction with respect to a reference position at which said image recording medium is not moved in said width direction, and an amount of movement is equal to or less than a width of end portions in said width direction cut in said cutting section.

5. The printer according to claim 1, wherein said the position adjusting section moves said image recording medium on both sides in said width direction with respect to a reference position at which said image recording medium is not moved in said width direction, and an amount of movement is equal to or less than half of a width of end portions in said width direction cut in said cutting subsection.
